(19) United States
(12) Patent Application Publication
(10) Pub. No.: US 2025/0194720 A1
(43) Pub. Date: Jun. 19, 2025

(54) SEVEN-PART GARMENT AND METHOD FOR ASSEMBLING SEVEN-PART GARMENT

(71) Applicant: 3A MEDICAL PRODUCTS CO., LTD., LIU AN (CN)

(72) Inventor: Ruolan YANG, LIU AN (CN)

(21) Appl. No.: 18/429,292

(22) Filed: Jan. 31, 2024

(30) Foreign Application Priority Data
Dec. 14, 2023 (CN) 202311717442.3

(51) Int. Cl. A41D 27/10

(52) U.S. Cl. CPC A41D 27/10; A41D 2300/52

(57) ABSTRACT

Disclosed are a seven-part garment and a method for assembling a seven-part garment. The method includes: cutting out a front part, a first back part, a second back part, a left sleeve upper part, a left sleeve lower part, a right sleeve upper part, and a right sleeve lower part from a fabric; bonding the left sleeve upper part to a left side edge of the front part, and bonding the right sleeve upper part to a right side edge of the front part; bonding the left sleeve lower part to the first back part, and bonding the right sleeve lower part to the second back part; and flattening, stacking, and aligning the front part with the first back part and the second back part, and bonding side edges of the front part to side edges of the first back part and the second back part to form the garment.

### CROSS-REFERENCE TO RELATED APPLICATION

This application claims priority to Chinese Patent Application 202311717442.3, filed on Dec. 14, 2023, which is incorporated herein by reference.

### FIELD

The present application relates to the technical field of garments, and in particular, to a seven-part garment and a method for assembling a seven-part garment.

### BACKGROUND

At present, for conventional disposable non-woven garments on the market, such as isolation gowns and surgical gowns, in a manufacturing process thereof, the fabric for assembling the garment is usually divided into three-, five-, six- and other parts. Specifically, each of the three-, five-, and six-part garments at least include a body part and two cylindrical sleeves connected to two sides of the body part. The cylindrical sleeves are usually sutured into a cylindrical shape manually and then sutured to both sides of the body part, or the cylindrical sleeves are first sutured to both sides of the body part manually and then sutured into a cylindrical shape. Due to the cylindrical shape of the sleeves and the soft nature of the non-woven fabric, automated assembling is difficult, and manual assembling is required, causing the problems of low assembling efficiency, low yield, and the like.

In addition, statistics on the amount of fabrics consumed for manufacturing the garments reveal that a V-shape or olive-shape where the existing sleeve joins the body part results in low fabric utilization and waste of fabrics. The front part, back part, and sleeves need to be cut out separately. The cutting process is cumbersome, with low manufacturing efficiency. Specifically, each sleeve part needs to be manually sutured onto the body part, resulting in low suturing efficiency. Furthermore, quality problems such as suturing omission, skipped stitches, puckers, dirt, holes, and the like may easily occur. Especially for medical supplies, the manual suturing process is complex. After being transferred among various processes, products can be easily polluted, with a high bacteria count.

### SUMMARY

In some embodiments of the present disclosure, a method for assembling a seven-part garment is provided. The method includes the following steps:
cutting out a front part, a first back part, a second back part, a left sleeve upper part, a left sleeve lower part, a right sleeve upper part, and a right sleeve lower part from a fabric;
bonding the left sleeve upper part to a left side edge of the front part, and bonding the right sleeve upper part to a right side edge of the front part;
bonding the left sleeve lower part to the first back part, and bonding the right sleeve lower part to the second back part; and
flattening, stacking, and aligning the front part with the first back part and the second back part, and bonding the left side edge and the right side edge of the front part to side edges of the first back part and the second back part to form the seven-part garment.

In a specific embodiment, the method may further include:
flattening, stacking, and aligning the left sleeve upper part and the left sleeve lower part, and bonding edges of the left sleeve upper part to the left sleeve lower part to form a left sleeve; and
flattening, stacking, and aligning the right sleeve upper part and the right sleeve lower part, and bonding edges of the right sleeve upper part to the right sleeve lower part to form a right sleeve.

In a specific embodiment, the left sleeve upper part and the right sleeve upper part are flattened and stacked and are symmetrically bonded to the left side edge and the right side edge of the front part respectively;
the first back part and the second back part are aligned, but not bonded; and
the left sleeve lower part is bonded to a left side edge of the first back part, and the right sleeve lower part is bonded to a right side edge of the second back part.

In a specific embodiment, necklines are arranged at edges of the front part, the first back part, and the second back part.

In a specific embodiment, each of the bonding the left sleeve upper part, the bonding the right sleeve upper part, the bonding the left sleeve lower part, the bonding the right sleeve lower part, and the bonding the left side edge and the right side edge of the front part comprises one or more of suturing, ultrasonic welding, high-frequency welding, hot-pressing, and gluing.

In a specific embodiment, step S3 of bonding the left sleeve lower part to the first back part, and bonding the right sleeve lower part to the second back part specifically includes:
flattening the front part, and aligning, flattening, and stacking the first back part and the second back part on top of the front part; and
flattening, stacking, and aligning the left sleeve lower part and the left sleeve upper part, bonding the left sleeve lower part to the first back part, aligning the right sleeve lower part with the right sleeve upper part, and bonding the right sleeve lower part to the second back part.

In a second aspect, a seven-part garment provided, including a front part, a first back part, a second back part, a left sleeve upper part, a left sleeve lower part, a right sleeve upper part, and a right sleeve lower part;
wherein the first back part and the second back part are combined to form a garment back;
side edges of the first back part and the second back part are flattened, stacked, and aligned with side edges of the front part, and are then bonded;
the left sleeve upper part and the right sleeve upper part are symmetrically flattened, stacked, and bonded to two side edges of the front part; and
the left sleeve lower part and the right sleeve lower part are symmetrically flattened, stacked, and bonded to side edges of the side edges of the first back part and the second back part.

In a specific embodiment, upper and lower edges of both the left sleeve upper part and the left sleeve lower part are aligned, flattened, and stacked and are bonded into a left sleeve; and
upper and lower edges of both the right sleeve upper part and the right sleeve lower part are aligned, flattened, and stacked and are bonded into a right sleeve.

In a specific embodiment, the side edges of the first back part and the second back part, and the side edges of the front part are provided with body part assembling lines.

In a specific embodiment, necklines are arranged at one end of the first back part close to the left sleeve and one end of the second back part close to the left sleeve; and edges of both the first back part and the second back part located on two sides of the necklines are aligned, flattened, and stacked on the front part and are provided with shoulder assembling lines.

### BRIEF DESCRIPTION OF THE DRAWINGS

For clearer descriptions of the technical solutions according to the embodiments of the present application, the drawings required to be used in the description of the embodiments are briefly introduced below. It is obvious that the drawings in the description below are only some embodiments of the present application, and it is obvious for those skilled in the art that other drawings can be acquired according to the drawings without creative efforts.

FIG. 1 to FIG. 3 show schematic diagrams of conventional three-part disposable isolation gown or surgical gown according to prior art;

FIG. 4 to FIG. 6 show schematic diagrams of conventional five-part disposable isolation gown or surgical gown according to prior art;

FIG. 7 shows a schematic diagram of a method for assembling a seven-part garment according to the present application;

FIG. 8 shows a schematic diagram of a layered structure of the seven-part garment according to the present application;

FIG. 9 shows a rear view of the seven-part garment according to the present application;

FIG. 10 shows a schematic structural diagram of a front part according to present application;

FIG. 11 shows a schematic diagram of a first back part according to the present application;

FIG. 12 shows a schematic diagram of a second back part according to the present application;

FIG. 13 shows a schematic diagram of a connection sites for the first back part and the second back part according to the present application;

FIG. 14 shows a schematic diagram of connection between the front part and a left sleeve upper part, as well as a right sleeve upper part, according to the present application;

FIG. 15 shows a schematic diagram of a strap structure of the seven-part garment according to the present application;

FIG. 16 shows a schematic diagram of assembling lines of the seven-part garment according to the present application; and

FIG. 17 to FIG. 19 show schematic diagrams of a method for assembling a seven-part garment in Embodiment II according to the present application.

### DETAILED DESCRIPTION

In order to make the objective, technical solutions, and advantages of the embodiments of the present application clearer, the technical solutions in the embodiments of the present application will be described clearly and completely below in combination with the drawings in the embodiments of the present application. Based on the embodiments of the present application, all other embodiments obtained by those skilled in the art without creative work shall fall within the protection scope of the present application.

It should be noted that when an element is referred to as being “fixed to” another element, the element can be directly on another component or there can be another element therebetween. When an element is considered to be “bonded” to another element, the element can be directly bonded to another element or there may be a centered element. The terms “vertical”, “horizontal”, “left”, “right”, and similar expressions used herein are for illustrative purposes only and do not necessarily represent the only implementation.

Unless otherwise defined, meanings of all technical and scientific terms used in this specification are the same as those usually understood by a person skilled in the art to which this application belongs. Terms used in the specification of the present disclosure herein are merely intended to describe the objectives of the specific implementations, but are not intended to limit the present application. The term “and/or” used herein includes any and all combinations of one or more related listed items.

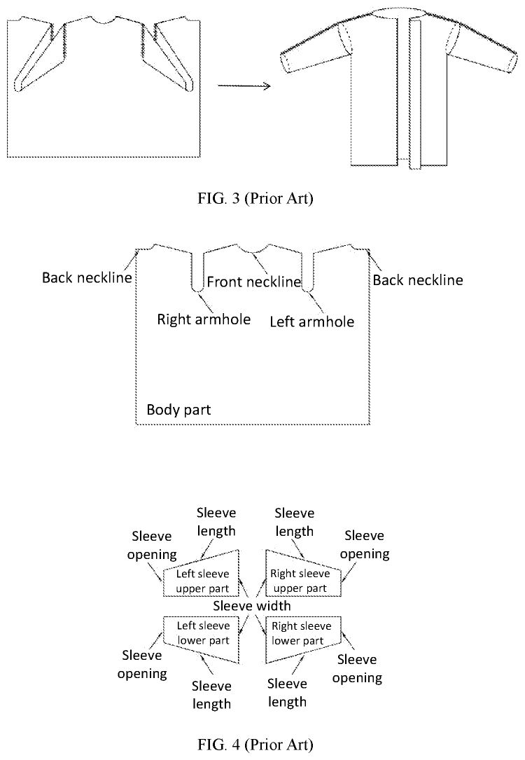

The term “up”, “upper”, “down”, “lower”, “left” and “right” used in the embodiments of the present application are based on orientations shown in FIG. 3 and FIG. 9.

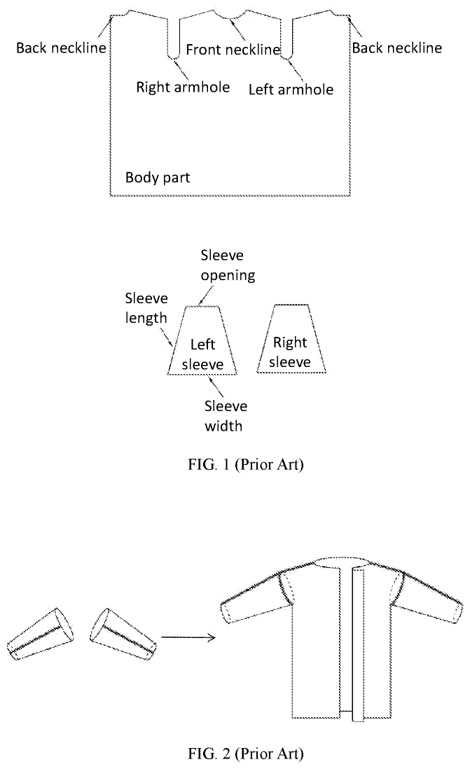

For existing three-part disposable non-woven isolation gown or surgical gown, FIG. 1 shows a structure of the three-part disposable non-woven isolation gown or surgical gown. From the drawings, it can be seen that the three-part disposable non-woven isolation gown or surgical gown includes a body-part and two sleeve parts, wherein the body part is composed of one single piece of fabric including a front body part and a back body part. Each sleeve is made of fabric that is trapezoid after being unfolded. During manufacturing, as shown in FIG. 2 and FIG. 3, the left and right sleeve parts are first combined into a cylindrical shape and are then sutured at arm holes, or sleeve width parts of the left and right sleeve parts are first sutured to arm holes of the body part, all the way along sleeve opening to the shoulder to form the garment. Although the complete disposable non-woven isolation gown or surgical gown can be formed by three-part assembled, the body-part is provided with a plurality of irregular garment connection openings, resulting in waste of fabric. Meanwhile, the body-part itself is assembled to form a complete body part. The process of manufacturing the garment is complex, and the production efficiency is low; quality problems easily occur; and the total bacterial count is high.

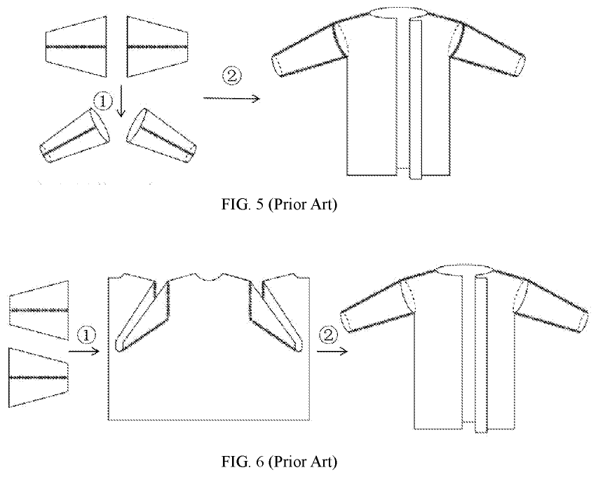

Existing five-part disposable non-woven isolation gown or surgical gown, as shown in FIG. 4 and FIG. 5, includes a front body part, a first back body part, a second back body part, and a first sleeve and a second sleeve which are bonded on two sides of the front body part, wherein the front body part is correspondingly assembled with the first back body part and the second back body part. The first sleeve and the second sleeve are cylindrical; connections between the first sleeve, as well as the second sleeve, and the body parts are set to be arc-shaped, V-shaped, or olive-shaped; and then the sleeves are sutured at arm holes. Alternatively, as shown in FIG. 6, the left and right sleeve lower parts are sutured together, and sleeve width parts of the left and right sleeve parts are sutured to arm holes of the body part, all the way along sleeve openings to the shoulders to form the garment. During actual cutting, a preset arc shape, V shape, or olive shape needs to be formed. Meanwhile, during assembling, manual suturing or welding greatly increases the workload of the assembling process and reduces the manufacturing efficiency.

Based on the above problems, the present application provides a method for assembling a seven-part garment. Through scientific and reasonable analysis, a piece of fabric is divided into seven parts, which saves fabric, assembles the entire garment more efficiently, and achieves more stable quality.

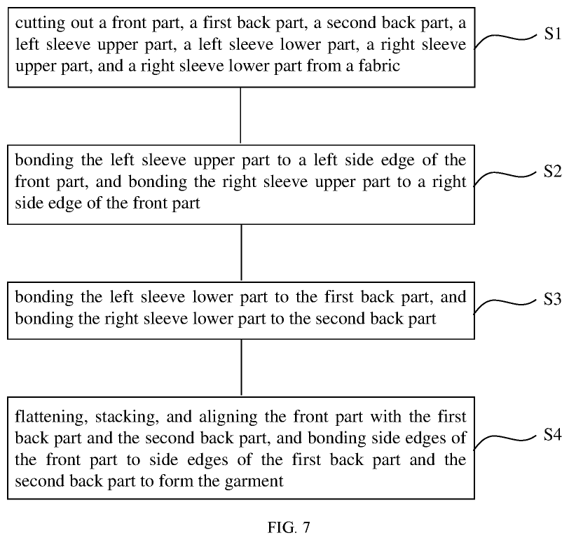

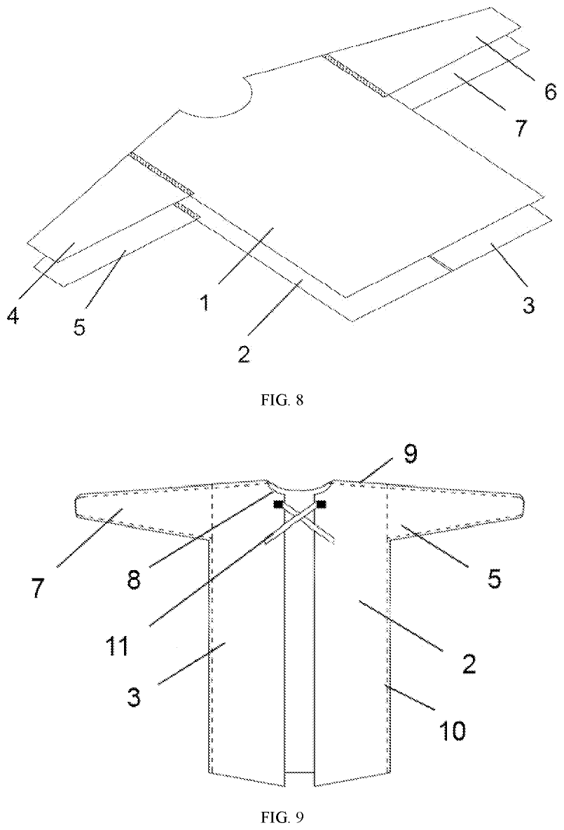

In Embodiment I, a method for assembling a seven-part garment is provided. As shown in FIG. 7 and FIG. 8, the method includes the following steps:

At step S1, a piece of fabric is cut into a front part 1, a first back part 2, a second back part 3, a left sleeve upper part 4, a left sleeve lower part 5, a right sleeve upper part 6, and a right sleeve lower part 7.

Preferably, the garment in this embodiment includes but is not limited to disposable isolation gowns, disposable surgical gowns/scrubs, protective garments, and daily garments.

The original fabric is prepared. As shown in FIG. 9, the fabric is cut into seven parts with preset shapes according to a preset shape and size. The front part 1 has the same length as the length of the first back part 2 and a length of the second back part 3. The left sleeve upper part 4 and the left sleeve lower part 5 have the same lengths and the same corresponding shapes. The right sleeve upper part 6 and the right sleeve lower part 7 have the same lengths and the same corresponding shapes. Meanwhile, the left sleeve upper part 4 and the right sleeve upper part have the same lengths and symmetric shapes.

At step S2, the left sleeve upper part 4 and the right sleeve upper part 6 are respectively bonded to a left side edge and a right side edge of the front part 1.

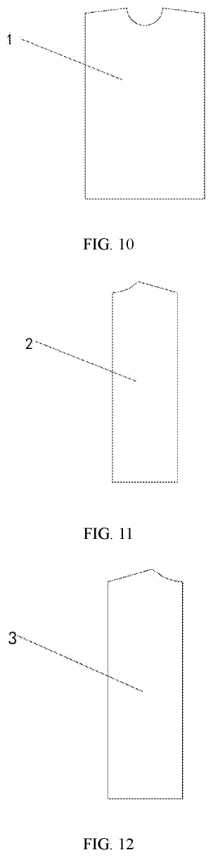

Firstly, the front part 1 is unfolded and flattened. As shown in FIG. 10, the left sleeve upper part 4 and the right sleeve upper part 6 are symmetrically flattened on the two sides of the front part 1, and one end of the left sleeve upper part 4 and one end of the right sleeve upper part 6 extend a certain distance into the front part 1, so that the left sleeve upper part 4 and the right sleeve upper part 6 can be conveniently assembled to the front part 1. Assembling and bonding are performed along overlapping parts between the left sleeve upper part 4, the right sleeve upper part 6, and the front part 1. The specific means for the assembling and bonding include one or more of manual suturing, ultrasonic welding, high cycle welding, hot-pressing, and gluing.

In step S3, the left sleeve lower part 5 is bonded to the first back part 2, and the right sleeve lower part 7 is bonded to the second back part 3.

This step specifically includes flattening the front part 1, and aligning, flattening, and stacking the first back part 2 and the second back part 3 on top of the front part 1. Structures of the first back part 2 and the second back part 3 are as shown in FIG. 11 and FIG. 12.

As shown in FIG. 13, the left sleeve lower part 5 is aligned with the left sleeve upper part 4, and the left sleeve lower part 5 is bonded to the first back part 2. The right sleeve lower part 7 is aligned with the right sleeve upper part 6, and the right sleeve lower part 7 is bonded to the second back part 3.

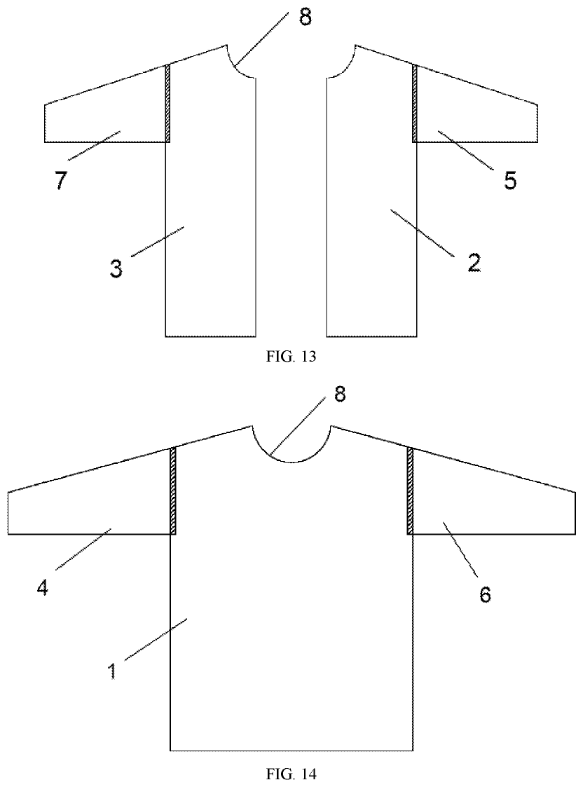

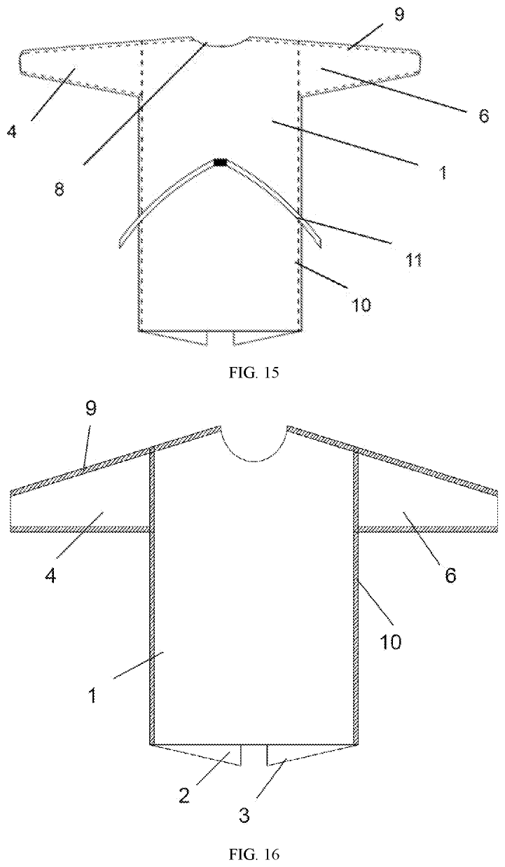

For example, as shown in FIG. 14, after the boding between the front part 1 and the left sleeve upper part 4, as well as the right sleeve upper part 6, is completed, the first back part 2 and the second back part 3 are flattened on two side edges of the front part 1, so that a gap is reserved between the first back part 2 and the second back part 3. The left sleeve lower part 5 and the right sleeve lower part 7 are respectively bonded to one side edge of the first back part 2 away from a central axis and one side edge of the second back part 3 away from the central axis. It ensures that one side edge of the first back part 2 away from the gap and one side edge of the second back part 3 away from the gap are aligned with two side edges of the front part 1.

The gap is reserved between the first back part 2 and the second back part 3, which greatly shortens the time of putting on and taking off protective garment during use and improves the convenience of putting on and taking off the protective garment.

In step S4, the front part 1 is stacked and aligned with the first back part 2 and the second back part 3, and two side edges of the front part 1 are assembled and bonded to the first back part 2 and the second back part 3 respectively.

As shown in FIG. 15, the state of stacking and aligning the front part 1 with the first back part 2 and the second back part 3 up and down in step S3 is continued to be maintained; and the left sleeve upper part 4 and the left sleeve lower part 5 are flattened and aligned and are then assembled and bonded along edges of the left sleeve upper part 4 and the left sleeve lower part 5, so as to form a left sleeve. The right sleeve upper part 6 and the right sleeve lower part 7 are flattened and aligned and are assembled and bonded along edges of the right sleeve upper part 6 and the right sleeve lower part 7, so as to form a right sleeve. Meanwhile, upper edges of the front part 1, the first back part 2, and the second back part 3 are assembled to form assembling lines at a collar of the disposable non-woven isolation gown or surgical gown.

Meanwhile, as shown in FIG. 15 and FIG. 16, the two side edges of the front part 1 are assembled in a vertical direction to a lower rim of the front part 1 from a lower part of the left sleeve and to the lower rim of the front part 1 along a lower part of the right sleeve, so as to assemble the two sides of the body part of the disposable non-woven isolation gown or surgical gown.

In a specific embodiment, necklines 8 are arranged at upper edges of the front part 1, the first back part 2, and the second back part 3. The front part 1, the first back part 2, and the second back part 3 at the necklines 8 are kept aligned from front to back. As shown in FIG. 13, further, in order to improve the stability of the disposable non-woven isolation gown or surgical gown on the body of a user when the user wearing the disposable non-woven isolation gown or surgical gown or the garment performs other operations, a strap 11 bonded to the first back part 2 and the second back part 3. Specifically, the size of the strap 11 is 4*180 cm, and two points are arranged in the middle of the strap 11 and are respectively bonded to the first back part 2 and the second back part 3. Two ends of the strap 11 are in a separated state for manual tightening of the isolation gown.

It should be noted that a mounting position of the strap 11 is not limited. The strap 11 can be mounted on the front part 1 according to an actual usage need. Accessories can also be added to the garment according to product performance and actual usage needs, including but not limited to a collar strap, a waist strap, a pocket, and sleeve openings (elastic or knitted sleeve openings).

In a specific embodiment, elastic or knitted sleeve openings are also arranged at one end of the left sleeve and one end of the right sleeve away from the front part 1, so as to tighten the sleeve openings of the left sleeve and the right sleeve.

It should be noted that the garment, such as isolation gowns, surgical gowns, scrubs, and protective garments, in the present application, can be added with various accessories according to its nature or scope of use, such as a hook and loop fastener, a strap, a pocket, sleeve openings (elastic or knitted sleeve openings), and a hang tag.

It should be noted that the garment in this embodiment includes but is not limited to isolation gowns, surgical gowns, scrubs, and protective garments.

Through the solution in this embodiment, the seven parts of fabrics are assembled in sequence according to an order to form a complete garment. On the one hand, full utilization of the fabric is achieved, and on the other hand, the seven-part setting is conducive to the efficient and automated assembling of the garment and improvement of the product quality.

In Embodiment II, corresponding to the above embodiment, this embodiment provides a method for assembling a seven-part garment. The specific process is as follows:

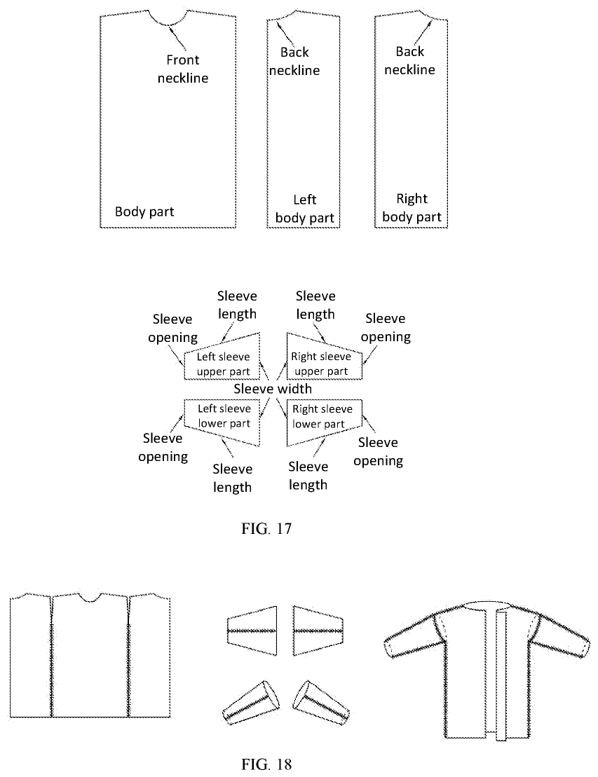

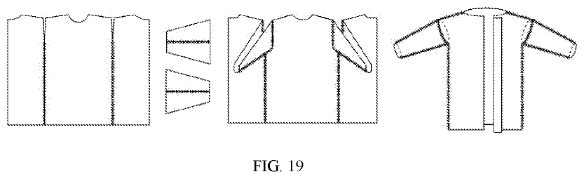

As shown in FIG. 17 and FIG. 18, a piece of original fabric is cut into a front part 1, a first back part 2, a second back part 3, a left sleeve upper part 4, a left sleeve lower part 5, a right sleeve upper part 6, and a right sleeve lower part 7; the first back part 2 and the second back part 3 are respectively sutured with the front part 1; the left sleeve upper part 4 and the left sleeve lower part 5 are sutured into a cylindrical shape to form a left sleeve; the right sleeve upper part 6 and the right sleeve lower part 7 are sutured into a cylindrical shape to form a right sleeve; and the left sleeve and the right sleeve are finally respectively sutured to arm holes to form the garment.

In a specific embodiment, as shown in FIG. 17 and FIG. 19, the first back part 2 and the second back part 3 are respectively sutured with the front part 1; one side edge of the left sleeve upper part 4 and one side edge of the left sleeve lower part 5 are then sutured; one side edge of the right sleeve upper part 6 and one side edge of the right sleeve lower part 7 are sutured; sleeve width parts of the left sleeve upper part 4 and the left sleeve lower part 5, as well as sleeve width parts of the right sleeve upper part 6 and the right sleeve lower part 7 are sutured to arm holes of the body part respectively, all the way along the sleeve openings to the shoulders to form the garment.

Through the solution in this embodiment, the seven parts of fabrics are assembled in sequence according to an order to form a complete garment, which has the effect of saving fabric and ensuring more stable quality, and improving the efficiency of fabric cutting.

In Embodiment III, corresponding to the above embodiment, this embodiment provides a seven-part garment manufactured by a method for assembling a seven-part garment, wherein the seven-part garment includes a front part 1, a first back part 2, a second back part 3, a left sleeve upper part 4, a left sleeve lower part 5, a right sleeve upper part 6, and a right sleeve lower part 7.

Specifically, as shown in FIG. 8, the first back part 2 and the second back part 3 are combined to form a garment back. The middle of the first back part 2 and the middle of the second back part 3 are not bonded, and there is a gap. One side of the first back part 2 away from the intermediate gap and one side of the second back part 3 away from the intermediate gap are aligned with an edge of the front part 1 and are assembled and bonded. The left sleeve upper part 4 and the right sleeve upper part 6 are symmetrically bonded to two sides of the front part 1. The left sleeve lower part 5 and the right sleeve lower part 7 are symmetrically bonded to two sides of the garment back.

Further, corresponding to connection sites and overlapping widths of the left sleeve upper part 4 and the front part 1, the left sleeve lower part 5 and the right sleeve lower part 7 are respectively assembled and bonded to one side of the first back part 2 and one side of the second back part 3, and the assembling of the left and right sides is completed.

In a specific embodiment, as shown in FIG. 15, necklines 8 are arranged at one end of the first back part 2 close to the left sleeve and one end of the second back part 3 close to the left sleeve. Depths of the necklines 8 at the first back part 2 and the second back part 3 are the same as the depth of a neckline 8 at the front part 1. Therefore, when the front part 1 and the two back parts are stacked together, the necklines 8 are flush with each other.

In order to complete the manufacturing of the garment more quickly and efficiently, as shown in FIG. 15 and FIG. 16, the front part 1 is aligned, flattened, and stacked together with the first back part 2 and the second back part 3, and assembling is performed along the left sleeve upper part 4 to the necklines 8. After the assembling, edges of two sides of the necklines 8 are aligned with the front part 1 and are assembled with a shoulder assembling line 9. Similarly, assembling is performed along the right sleeve upper part 6 to the necklines 8 to form a shoulder assembling line 9 on the right side. Then, the side of the first back part 2 away from the intermediate gap, the side of the second back part 3 away from the intermediate gap, and the edge of the front part 1 are assembled with a body part assembling line 10, thus forming a complete garment.

In a specific embodiment, upper and lower edges of both the left sleeve upper part 4 and the left sleeve lower part 5 are aligned, stacked, and flattened, and are assembled and bonded to form the left sleeve. The upper and lower edges of both the right sleeve upper part 6 and the right sleeve lower part 7 are aligned, stacked, and flattened and are assembled and bonded to form the right sleeve. Elastic members are also arranged at a sleeve opening of the left sleeve and a sleeve opening of the right sleeve to facilitate tightening of the sleeve openings.

In a specific embodiment, straps 11 are also assembled and bonded to the first back part 2 and the second back part 3. Two points are arranged in the middle of the straps 11 and are respectively bonded to the first back part 2 and the second back part 3. Two ends of the straps 11 are in a separate state for manual tightening of the isolation gown.

Optionally, accessories can also be added to the garment according to product performance and actual usage needs, including but not limited to a collar strap, a waist strap, a pocket, and sleeve openings (elastic or knitted sleeve openings).

The embodiments of the present disclosure have the following beneficial effects:

1. According to the embodiments of the present application, the fabric is cut into the front part, the first back part, the second back part, the left sleeve upper part, the left sleeve lower part, the right sleeve upper part, and the right sleeve lower part; each part is correspondingly flattened, stacked, and connected to a corresponding position; the seven parts of fabrics are assembled according to an order to form a complete garment; and the automated production can be used to assemble the entire garment more efficiently, and the quality is more stable. Furthermore, the present application has the effects of saving fabrics and improving the cleanness of the manufactured garment.

2. The back of the garment is divided into the first back part and the second back part, and outer edges of the first back part and the second back part are assembled and connected to the front part respectively; a gap is reserved between the first back part and the second back part, so that the time of putting on and taking off the garment during use is greatly shortened; and the convenience of putting on and taking off the garment is improved.

It should be noted that the garment in this embodiment includes but is not limited to isolation gowns, surgical gowns, scrubs, and protective garments. Through the solution in this embodiment, the seven parts of fabrics are assembled in sequence according to an order to form a complete garment, which saves cloth, assembles the entire garment more efficiently, and achieves more stable quality.

The foregoing descriptions are merely preferred embodiments of this application, but are not intended to limit this application. Any modification, equivalent replacement, or improvement made without departing from the spirit and principle of this application should fall within the protection scope of this application.

What is claimed is:

1. A method for assembling a seven-part garment, comprising:
cutting out a front part, a first back part, a second back part, a left sleeve upper part, a left sleeve lower part, a right sleeve upper part, and a right sleeve lower part from a fabric;
bonding the left sleeve upper part to a left side edge of the front part, and bonding the right sleeve upper part to a right side edge of the front part;
bonding the left sleeve lower part to the first back part, and bonding the right sleeve lower part to the second back part; and
flattening, stacking, and aligning the front part with the first back part and the second back part, and bonding the left side edge and the right side edge of the front part to side edges of the first back part and the second back part to form the seven-part garment.

2. The method for assembling the seven-part garment according to claim 1, further comprising:
flattening, stacking, and aligning the left sleeve upper part and the left sleeve lower part, and bonding edges of the left sleeve upper part to the left sleeve lower part to form a left sleeve; and
flattening, stacking, and aligning the right sleeve upper part and the right sleeve lower part, and bonding edges of the right sleeve upper part to the right sleeve lower part to form a right sleeve.

3. The method for assembling the seven-part garment according to claim 2,
wherein, the left sleeve upper part and the right sleeve upper part are flattened and stacked and are symmetrically bonded to the left side edge and the right side edge of the front part respectively;
the first back part and the second back part are aligned, but not bonded; and
the left sleeve lower part is bonded to a left side edge of the first back part, and the right sleeve lower part is bonded to a right side edge of the second back part.

4. The method for assembling the seven-part garment according to claim 3, wherein, necklines are arranged at edges of the front part, the first back part, and the second back part.

5. The method for assembling the seven-part garment according to claim 1,
wherein, each of the bonding the left sleeve upper part, the bonding the right sleeve upper part, the bonding the left sleeve lower part, the bonding the right sleeve lower part, and the bonding the left side edge and the right side edge of the front part comprises one or more of suturing, ultrasonic welding, high cycle welding, hot-pressing, and gluing.

6. The method for assembling the seven-part garment according to claim 1, wherein the step of bonding the left sleeve lower part to the first back part, and bonding the right sleeve lower part to the second back part comprises:
flattening the front part, and aligning, flattening, and stacking the first back part and the second back part on top of the front part; and
flattening, stacking, and aligning the left sleeve lower part and the left sleeve upper part, bonding the left sleeve lower part to the first back part, aligning the right sleeve lower part with the right sleeve upper part, and bonding the right sleeve lower part to the second back part.

7. A seven-part garment, comprising a front part, a first back part, a second back part, a left sleeve upper part, a left sleeve lower part, a right sleeve upper part, and a right sleeve lower part, wherein:
the first back part and the second back part are combined to form a back part;
a left side edge of the first back part and a right side edge of the second back part are flattened, stacked, aligned with and then bonded to a left side edge and a right side edge of the front part respectively;
the left sleeve upper part and the right sleeve upper part are symmetrically flattened, stacked, and bonded to the left side edge and the right side edge of the front part respectively; and
the left sleeve lower part and the right sleeve lower part are symmetrically flattened, stacked, and bonded to a left side edge and a right side edge of the back part respectively.

8. The seven-part garment according to claim 7, wherein upper and lower edges of both the left sleeve upper part and the left sleeve lower part are aligned, flattened, and stacked and are assembled and bonded into a left sleeve; and
upper and lower edges of both the right sleeve upper part and the right sleeve lower part are aligned, flattened, and stacked and are assembled and bonded into a right sleeve.

9. The seven-part garment according to claim 8, wherein the left side edge of the first back part, the right side edge of the second back part, and the left side edge and right side edge of the front part are provided with body part assembling lines.

10. The seven-part garment according to claim 9, wherein necklines are arranged at one end of the first back part close to the left sleeve and one end of the second back part close to the left sleeve; and
edges of both the first back part and the second back part located on two sides of the necklines are aligned, flattened, and stacked on the front part and are provided with shoulder assembling lines.
